(19) United States
(12) Patent Application Publication
(10) Pub. No.: US 2020/0348326 A1
(43) Pub. Date: Nov. 5, 2020

(54) Fluidic Sample Pretreatment Device

(71) Applicant: Ilkka Johannes Lahdesmaki, Seattle, WA (US)

(72) Inventor: Ilkka Johannes Lahdesmaki, Seattle, WA (US)

(73) Assignee: FIAlab Instruments, Inc., Seattle, WA (US)

(21) Appl. No.: 16/403,390

(22) Filed: May 3, 2019

(51) Int. Cl. G01N 35/10; G01N 35/08; G01N 1/40

(52) U.S. Cl. CPC G01N 35/1097; G01N 2035/1032; G01N 1/405; G01N 35/085

(57) ABSTRACT

A fluidic sample pretreatment device is described. The device is capable of manipulating fluid samples in several different manners: 1) mixing the sample with other fluids in a large-bore syringe and receptacle, 2) mixing the sample with other fluids in narrow-bore capillary channels, 3) treating the sample or fluid mixture by passage through a solid-phase sorbent cartridge, 4) measuring optical properties in the sample or fluid mixture by means of UV absorbance or fluorescence, 5) subjecting the sample fluid or fluid mixture to a controlled temperature. The device can transfer the treated sample to an analytical instrument (e.g. a chromatograph or a mass spectrometer) for separation and/or analysis.

The device is unique and novel in combining capabilities of fluid mixing both in a large-bore syringe barrel, as well as in narrow-bore tubing. Moreover, in-syringe mixing is promoted by liquid movement between the syringe and the receptacle, rather than by a stir bar located in the syringe. A further unique feature is the use of flow-through ports for feature integration on the selector valve: both a sample introduction point and an optional solid-phase sorbent cartridge are incorporated in this manner.

### BACKGROUND OF THE INVENTION

The present invention relates to automated physical and chemical manipulation of a fluid sample, for the purpose of preparing the sample for analysis on another instrument (e.g. chromatography, mass spectrometry). Furthermore, it relates to measurement of the optical properties of the sample fluid or fluid mixture, for the purpose of monitoring progress of the preparation process.

When fluid samples are analyzed by means of optical spectrometry, liquid chromatography or mass spectrometry, it is often necessary to first subject the sample to chemical and physical pretreatment. Pretreatment is required for purposes such as removing interfering substances in the sample matrix, rendering the sample in a more dilute, or more concentrated form or altering the physical, chemical or optical properties of the sample to facilitate its analysis. These operations are carried out by mechanisms like solvent addition, solid phase extraction followed by elution, or reactive treatment of the sample via chemical derivatization. For derivatization reactions, controlled temperature conditions are often desired for reaction speed and reproducibility.

When measurements are performed in a laboratory setting, such pretreatment is usually carried out manually by an analyst. For process monitoring measurements, however, an automated pretreatment method is strongly preferred. Devices exist for simple automated pretreatment operations, but those are usually restricted to the very elemental unit operations of sample transfer and dilution. Examples of automated dilution devices are described in US Pat 2012/0103075 A1 and US Pat 2016/0077060 A1.

A more advanced fluid sample manipulation technology called Sequential Injection (SI) has been developed as a result of academic research (Lenehan et al. Analyst 2002, 127, 997-1020). The SI technology allows very flexible sample treatment by mixing the sample with other fluids, as well as subjecting the mixture to in-line heating, solid-phase extraction, gas diffusion, dialysis etc. From a mechanical perspective, SI is based on a bi-directional syringe/piston/plunger pump for propelling fluid movement, and a selector valve for directing the device to the correct fluid source or destination for each step of the pretreatment routine. The pump is used to pull sample and reagent segments through the selector valve ports, into a coil of capillary tubing located between the pump and the valve. Mixing occurs in the tubing coil, as the aspirated fluid segments are moved back and forth by the pump. Such devices have been manufactured commercially and certain specific configurations and applications have been patented (US Pat 1995/5721135A, 1995/5695720A, 2001/6887429B1 and 2005/0244299A1).

As mentioned above, the basic premise of SI is mixing fluid segments inside narrow-bore capillary tubing. This allows easy mixing of small fluid volumes, but suffers from the downside that homogeneous mixing is nearly impossible due to the restrictive geometry of the narrow-bore channel. For the same reason, mixing more than three fluid components together is challenging, as the first and the last components introduced into the capillary tube will hardly come in contact with one another. At times, mixing chambers with stir bars have been used to achieve complete mixing of multiple components as shown in US Pat 2001/6887429B1. However, mixing chambers tend to be problematic since it takes a large volume of solution to clear the chamber of its previous contents before the next sample processing cycle can begin.

A variant of the traditional SI setup has been utilized for liquid-liquid extraction where a mechanical syringe on a syringe pump is used as a mixing chamber (Suarez et al., Talanta, 2014, vol. 130, p. 555-560; Maya et al., Anal Bioanal Chem, 2012, vol. 404, p. 909-917). A stir bar or magnetic beads inside the syringe are used to achieve proper mixing. Such a system offers the advantage that the syringe piston can be compressed to squeeze out the syringe contents, which clears the mixing compartment much more efficiently compared to a traditional stirred tank chamber. The inclusion of a mechanical stirring component inside the syringe is useful for liquid-liquid extraction where vigorous mixing is required. However, it limits the degree to which the contents can be expelled, and introduces mechanical complexity to the apparatus.

While most SI systems focus on sample treatment by means of liquid chemicals, solid-phase sorbents have also been used. This is especially useful for preconcentration and interference removal purposes, if the sorbent material selectively binds the analyte of interest. Sometimes, SI systems include solid-phase media in form of mobile microbead suspension, as illustrated by US Pat 1995/5721135A. Most often, a static cartridge filled with solid-phase extraction media is connected in-line as part of the SI instrument manifold. An issue with the use of solid-phase extraction cartridges in SI setups is recovering the eluted analyte from the exit end of the cartridge. Recovery is possible by using a mixing tee on the exit end, one branch of the tee connecting to a tube that holds the eluted analyte as it is pushed out of the column. The other tee branch connects to a port on the SI selector valve, which now can be used for pulling the eluted analyte back into the SI system for further processing. While functional, the arrangement introduces dead volume and complexity in form of additional tubing and connectors.

The present invention outlines an apparatus for sample preparation purposes. Specifically, the apparatus enables 1) direct fluid aspiration into a syringe, followed by mixing of the fluids inside the syringe barrel, 2) enhanced in-syringe mixing by using a mixing receptacle mounted directly onto the syringe pump, 3) mixing of fluids in narrow-bore capillary tubing, 4) treatment of fluids on a solid-phase extraction (SPE) cartridge, 5) feeding the SPE cartridge effluent directly back to the apparatus by utilizing a modification to the selector valve, 6) monitoring of the quality and progress of the sample treatment process by UV-VIS absorbance spectrometry or fluorimetry, 7) subjecting the sample fluid or fluid mixture to a controlled temperature.

### SUMMARY OF THE INVENTION

The present invention provides an apparatus for physical and chemical manipulation of a fluid sample, for the purpose of pretreatment before subsequent analysis. The apparatus mixes the sample with reagent fluids inside the barrel of a syringe, aided by a mixing receptacle. It also enables mixing of fluids inside a narrow-bore capillary tube. It can incorporate a solid phase extraction cartridge for treating the sample fluid on a solid sorbent. It can incorporate an absorbance or fluorescence detector for monitoring the quality and progress of the sample treatment process. Furthermore, it can incorporate in-line temperature control units for thermal treatment of the sample or a sample-reagent mixture at different stages of the treatment process.

The apparatus comprises
(a) a syringe pump, with a head valve that has one port for syringe attachment and nine ports connected to fluid reservoirs or receptacles
(b) a mixing receptacle unit connected to the top (middle) port of the pump head valve
(c) a selector valve, modified so that two of the ports are connected by a groove on the backside of the valve stator. Such a modification is used in two locations on the valve.
(d) optional heater cartridges for controlling fluid temperature in selected locations
(e) an optional UV-VIS or fluorescence detector for monitoring the progress of the fluid treatment process in selected locations

### BRIEF DESCRIPTION OF THE DRAWINGS

FIG. 1 is a schematic representation of the apparatus where the mixing receptacle is a large-bore barrel.

FIG. 2 is a schematic representation of a modified apparatus where the mixing receptacle is a coil of narrow-bore capillary tubing.

FIG. 3 is a schematic representation of a modified apparatus where the mixing receptacle is a coil of narrow-bore capillary tubing, mounted inside or onto a temperature control element.

FIG. 4 is a schematic representation of a modified apparatus using a detection cell to monitor the solid-phase sorbent cartridge effluent stream.

FIG. 5 illustrates how the sample is delivered through the solid-phase sorbent cartridge and how the effluent following elution is pulled back to the apparatus for further processing.

FIG. 6 illustrates an alternative setup where the sample is delivered through the cartridge in an identical manner to FIG. 5, but pulled back through a different port position.

### DETAILED DESCRIPTION OF THE DISCLOSED EMBODIMENTS

The present invention describes a fluid sample pretreatment unit that is capable of mixing the sample with other fluids either in a large-bore barrel or inside narrow-bore tubing. The apparatus includes optional components for in-line temperature control, solid-phase sorbent treatment and optical measurements.

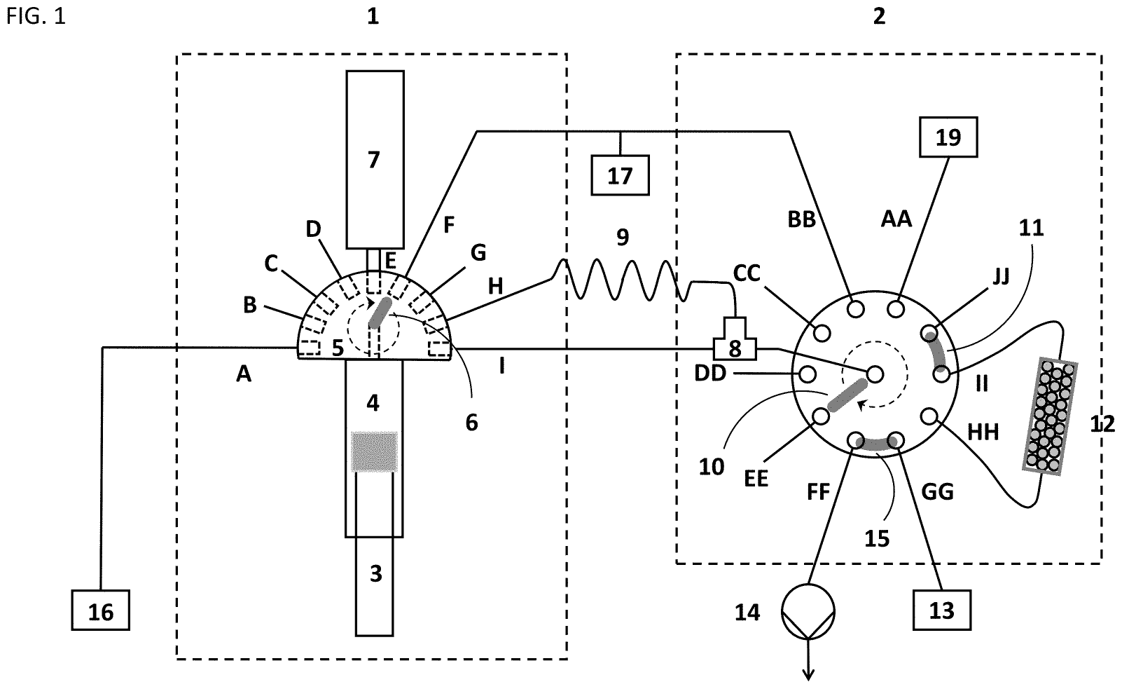

FIG. 1 shows a schematic view of the apparatus. It consists of two main units: a syringe pump 1 and a selector valve 2. The piston 3 of the syringe pump 2 is used to aspirate fluids into the syringe 4 from fluid inlet ports A, B, C, D and G. Port A has a specific purpose of connecting to a reservoir 16 of carrier solution, used for propulsion and/or dilution purposes. Ports H and I are used either for fluid aspiration or dispensation via the selector valve 2. Port F is connected to a waste container 17, so that spent fluids, including syringe wash fluid, can be expelled from the syringe 4. Selection of fluid source or destination is controlled with the aid of a rotating selector groove 6 on the pump head 5.

A mixing receptacle 7 is connected to port E. Sample fluid is mixed with pretreatment fluids by aspirating said fluids into the syringe, and repeatedly expelling them into the mixing receptacle 7, followed by aspirating them back into the syringe 4. Pretreatment fluids can also be aspirated from ports CC, DD, EE, FF, GG or JJ on the selector valve 2, with the pump connected to port I.

Selection of fluid source or destination on the selector valve 2 is controlled with the aid of a rotating selector groove 10. Small volumes of sample and pretreatment fluids can be partially mixed in the holding coil 9, made of coiled capillary tubing, by sequentially aspirating them from ports CC, DD, EE, FF, GG or JJ on the selector valve 2, via port H on the syringe pump. A mixing tee 8 is used to allow alternate use of either port H or port I to access ports on the selector valve 2 from the syringe pump 1, depending on whether the fluids should go directly to the syringe 4 (via port I) or be mixed before entering the syringe 4 (via holding coil 9 and port H).

A groove 15 is routed on the back side of the selector valve stator, permanently connecting ports FF and GG into a flow-through port. This feature is utilized for transferring sample fluid from the sample source 13 to the apparatus. Specifically, a sampling pump 14 is used to pull a controlled amount of sample from the sample source 13 past the flow-through port FF-GG. The syringe pump 1 can then be used to aspirate an aliquot of sample fluid into the syringe 4.

Port BB on the selector valve 2 is connected to waste, allowing spent solutions and wash solutions to be expelled from the apparatus. Ports HH and II are used to connect a solid-phase extraction (SPE) cartridge 12 to the selector valve 2. Port JJ is used to collect the effluent of the SPE cartridge 12, as well as to aspirate it back to the apparatus for further processing. Minimal dead volume for effluent collection is made possible by modification of the stator of the selection valve 2: a groove 11 is routed on the back side of the valve stator, permanently connecting ports II and JJ. This arrangement routes the effluent from the SPE cartridge 12 directly to port JJ, allowing the apparatus to access the effluent for further processing.

Port AA on the selector valve 2 is connected to an analytical device 19 (e.g. a chromatograph or a mass spectrometer) that the sample is delivered to after the treatment process is complete.

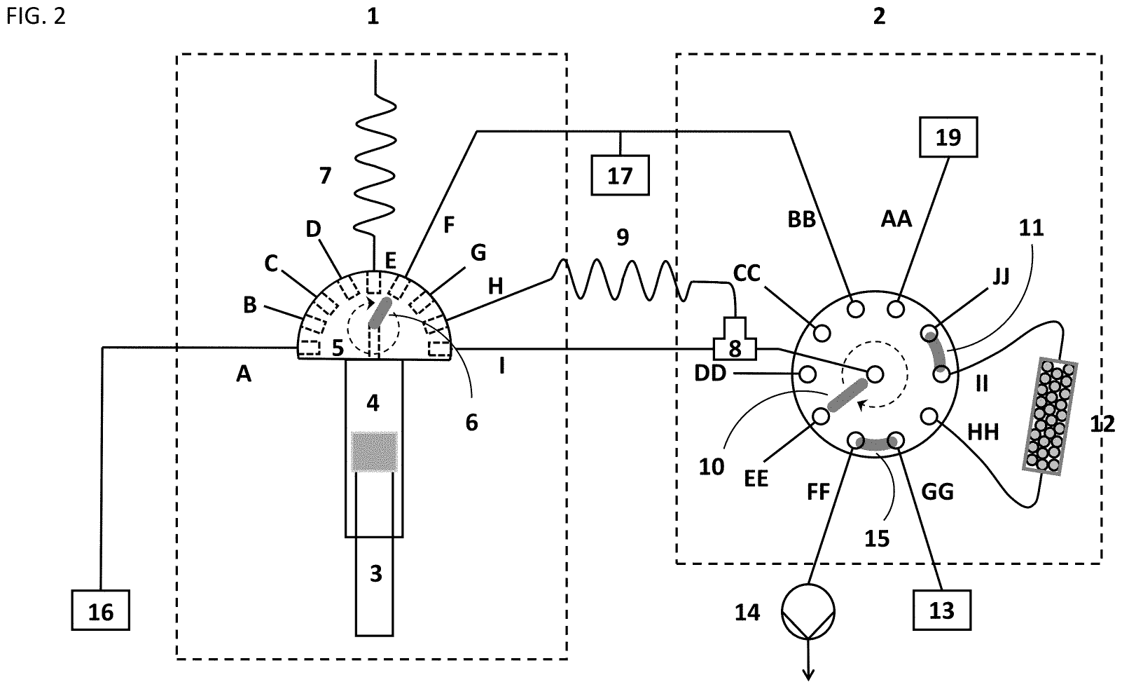

FIG. 2 shows an alternative configuration of the apparatus where the mixing receptacle 7 is coiled capillary tubing.

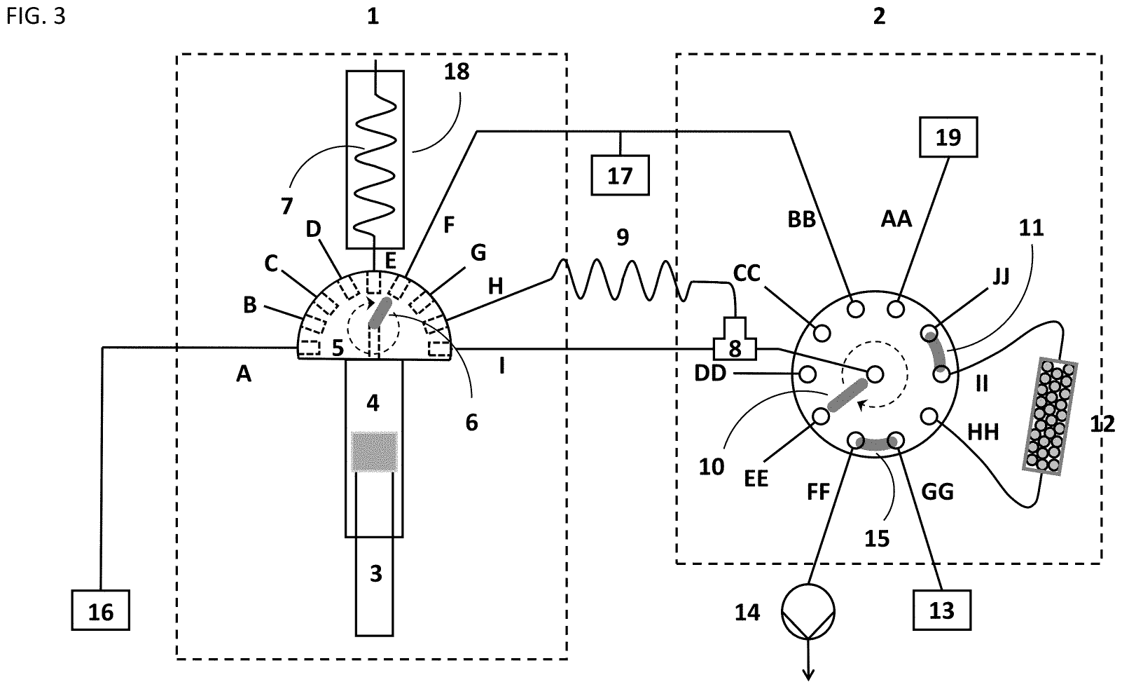

FIG. 3 shows an alternative configuration of the apparatus where the mixing receptacle 7 is coiled capillary tubing, with a heating element 18 that controls the temperature of the mixing receptacle.

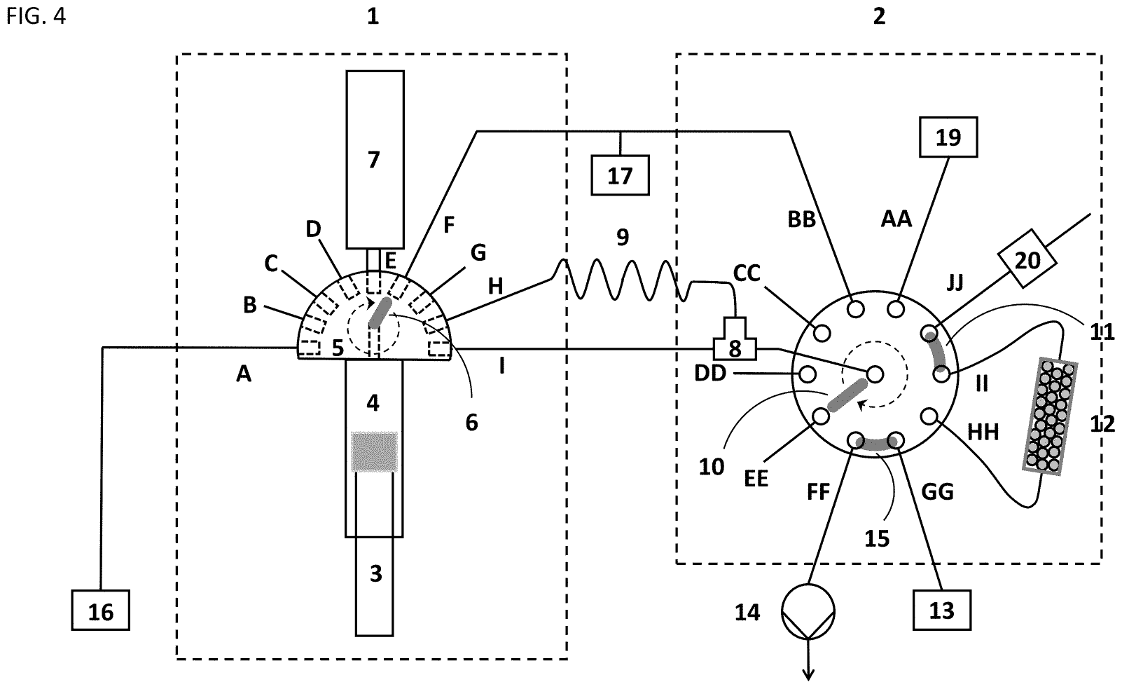

FIG. 4 shows an alternative configuration of the apparatus where a detector 20 (e.g. absorbance or fluorescence) is placed on the effluent line of the solid-phase sorbent column 12. Such an arrangement can be used for monitoring the efficiency of the solid-phase extraction process, or to test the condition and performance of the sorbent column.

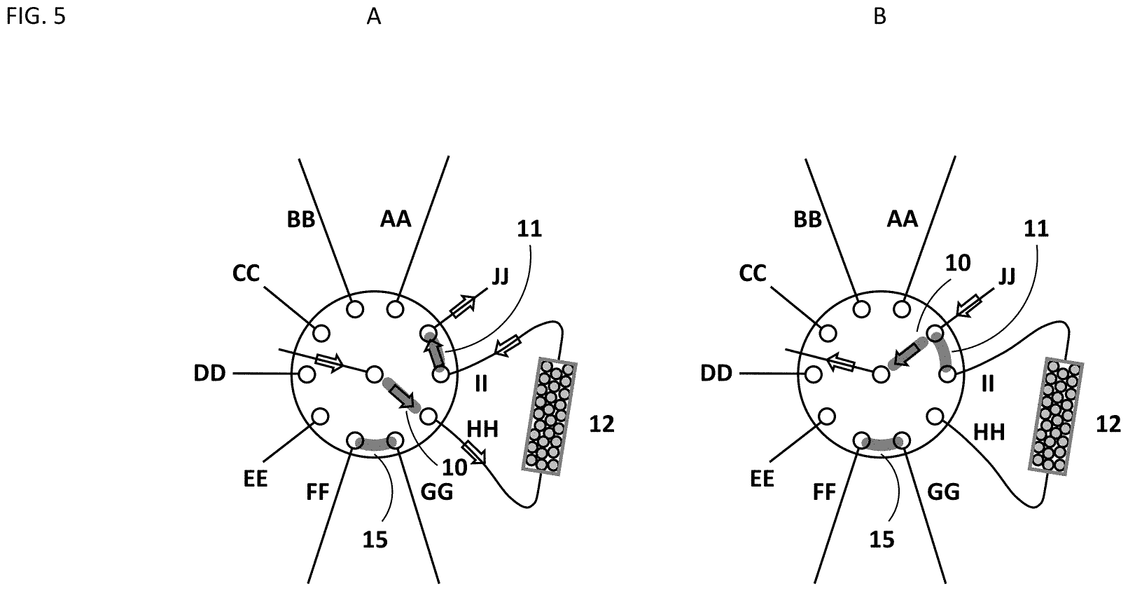

FIG. 5A shows how sample fluid, or a mixture of sample and reagent fluids, is applied on the solid-phase sorbent column 12, by pushing it through port HH. FIG. 5B shows how the effluent solution from the solid-phase sorbent column 12 is aspirated back into the apparatus. Aspiration takes place with the selector groove 10 in position JJ. In that case, the effluent solution is aspirated directly from the fluid line connected to port JJ.

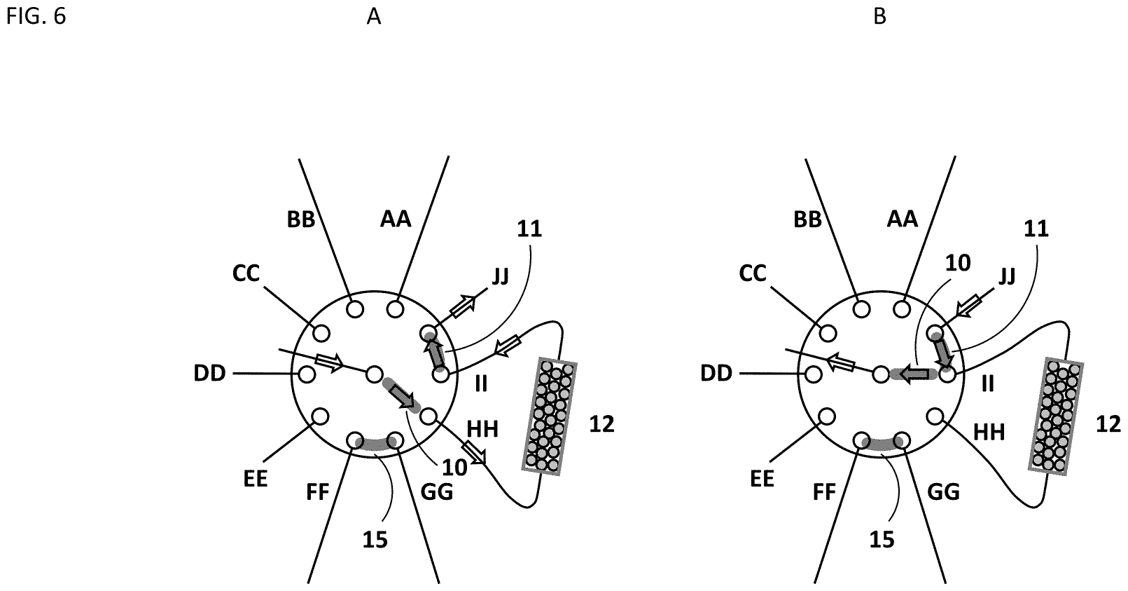

FIGS. 6A and 6B show an alternative route of aspirating the effluent. Application onto the column is done in an identical manner to FIG. 5A, i.e. via port HH. Aspiration, in contrast, is carried out with the selector groove 10 in position II. The effluent being aspirated still originates from the fluid line connected to port JJ, but travels through the flow-through groove 11 on its way of being pulled out. The alternative aspiration site allows sampling the column effluent in a slightly different part of the elution profile.

The previously unknown feature of the present invention is providing a design for a pretreatment device that allows mixing either in narrow-bore tubing or inside a syringe. Also previously unknown is the use of a mixing receptacle, with the options of employing a large-bore chamber, coiled tubing, or temperature-controlled coiled tubing as the receptacle. Also previously unknown is the use of built-in flow-through ports to facilitate sample transfer into the apparatus, as well as sample processing by solid-phase media. Also previously unknown is the alternate connection scheme between the syringe pump and the selector valve, allowing fluid transfer between the pump and the valve either directly or through a longer length of coiled tubing.

While certain specific details and embodiments have been described to illustrate the principles of the present invention, it will be apparent to those skilled in the art that many modifications are possible within the scope of the disclosed invention.

### Patent Citations

U.S. Pat. No. 5,721,135 A, BioImage AS, Apparatus for identifying biologically active substances by their effect on living cells

U.S. Pat. No. 5,695,720 A, B C Research Inc, Flow analysis network apparatus

U.S. Pat. No. 6,887,429 B1, Global FIA Inc, Apparatus and method for automated medical diagnostic tests

U.S. Pat. No. 0,103,075 A1, Waters Technologies Corp., Automated dilution for liquid chromatography

U.S. Pat. No. 0,077,060 A1, Waters Technologies Corp., Process sample and dilution systems and methods of using the same

U.S. Pat. No. 0,244,299 A1, Biowittaker Technologies Inc., Automated sequential injection analysis systems for the determination of trace endotoxin levels

Lenehan C. E., Barnett N. W., Lewis S. W., “Sequential injection analysis”, Analyst 2002, vol. 127, p. 997-1020.

Maya F., Horstkotte B., Estela J. M., Cerda V., “Lab in a syringe: fully automated dispersive liquid-liquid microextraction with integrated spectrophotometric detection”, Anal Bioanal Chem, 2012, 404, p. 909-917.

Suarez R. Horstkotte B., Cerda V., “In-syringe magnetic stirring-assisted dispersive liquid-liquid microextraction for automation and downscaling of methylene blue active substances assay”, Talanta 2014, vol. 130, p. 555-560.

What is claimed is:

1. An apparatus for automated fluidic sample pretreatment, comprising:
a. a syringe pump, equipped with a 9-port head valve
b. a mixing receptacle, consisting of a large-bore barrel, attached to the middle port of the syringe pump head valve
c. a multipositional fluid selector valve, in fluidic connection with the syringe pump, either/both via a short straight capillary tube or/and a long coiled capillary tube
d. a modification on the selector valve stator, connecting two ports to create a flow-through port for routing the effluent of a solid-phase extraction cartridge
e. a solid-phase extraction cartridge, connected to a modified flow-through port on the multipositional selector valve
f. a modification on the selector valve stator, connecting two ports to create a flow-through port for routing the intake of sample fluid
g. a source of sample, connected to a modified flow-through port on the multipositional selector valve
h. a sampling pump, connected to a modified flow-through port on the multipositional selector valve
i. sources of reagents, buffers, diluents and solvents, connected either to the syringe pump head valve, or to the multipositional selector valve
j. a fluidic connection from the multipositional selector valve to an analytical device that the sample is transferred to following completion of the pretreatment process

2. An apparatus for automated sample pretreatment, comprising:
a. a syringe pump, equipped with a 9-port head valve
b. a mixing receptacle, consisting of a coil of narrow-bore capillary tubing, attached to the middle port of the syringe pump head valve
c. a multipositional fluid selector valve, in fluidic connection with the syringe pump, either/both via a short straight tube or/and a long coiled tube
d. a modification on the selector valve stator, connecting two ports to create a flow-through port for routing the effluent of a solid-phase extraction cartridge
e. a solid-phase extraction cartridge, connected to a modified flow-through port on the multipositional selector valve
f. a modification on the selector valve stator, connecting two ports to create a flow-through port for routing the intake of sample fluid
g. a source of sample, connected to a modified flow-through port on the multipositional selector valve
h. a sampling pump, connected to a modified flow-through port on the multipositional selector valve
i. sources of reagents, buffers, diluents and solvents, connected either to the syringe pump head valve, or to the multipositional selector valve
j. a fluidic connection from the multipositional selector valve to an analytical device that the sample is transferred to following completion of the pretreatment process

3. An apparatus for automated sample pretreatment, comprising:
a. a syringe pump, equipped with a 9-port head valve
b. a mixing receptacle, consisting of a coil of narrow-bore capillary tubing, mounted onto or inside a temperature control element, and attached to the middle port of the syringe pump head valve
c. a multipositional fluid selector valve, in fluidic connection with the syringe pump, either/both via a short straight tube or/and a long coiled tube
d. a modification on the selector valve stator, connecting two ports to create a flow-through port for routing the effluent of a solid-phase extraction cartridge
e. a solid-phase extraction cartridge, connected to a modified flow-through port on the multipositional selector valve
f. a modification on the selector valve stator, connecting two ports to create a flow-through port for routing the intake of sample fluid
g. a source of sample, connected to a modified flow-through port on the multipositional selector valve
h. a sampling pump, connected to a modified flow-through port on the multipositional selector valve
i. sources of reagents, buffers, diluents and solvents, connected either to the syringe pump head valve, or to the multipositional selector valve
j. a fluidic connection from the multipositional selector valve to an analytical device that the sample is transferred to following completion of the pretreatment process

4. An apparatus for automated sample pretreatment, comprising:
a. a syringe pump, equipped with a 9-port head valve
b. a mixing receptacle, consisting of a large-bore barrel, a coil of capillary tubing, with or without a temperature control element, and attached to the middle port of the syringe pump head valve
c. a multipositional fluid selector valve, in fluidic connection with the syringe pump, either/both via a short straight tube or/and a long coiled tube
d. a modification on the selector valve stator, connecting two ports to create a flow-through port for routing the effluent of a solid-phase extraction cartridge
e. a flow-through type detector placed on the effluent line of the solid-phase extraction cartridge
f. a solid-phase extraction cartridge, connected to a modified flow-through port on the multipositional selector valve
g. a modification on the selector valve stator, connecting two ports to create a flow-through port for routing the intake of sample fluid
h. a source of sample, connected to a modified flow-through port on the multipositional selector valve
i. a sampling pump, connected to a modified flow-through port on the multipositional selector valve
j. sources of reagents, buffers, diluents and solvents, connected either to the syringe pump head valve, or to the multipositional selector valve
k. a fluidic connection from the multipositional selector valve to an analytical device that the sample is transferred to following completion of the pretreatment process
